(19) United States
(12) Patent Application Publication
(10) Pub. No.: US 2026/0127390 A1
(43) Pub. Date: May 7, 2026

(54) COMPUTING DEVICE (VARIANTS) AND METHOD FOR TRANSLATING WORDS INTO A TARGET LANGUAGE

(71) Applicant: Vladimir Aleksandrovich SIBUL, Saint Petersburg (RU)

(72) Inventor: Vladimir Aleksandrovich SIBUL, Saint Petersburg (RU)

(21) Appl. No.: 19/434,979

(22) Filed: Dec. 29, 2025

Related U.S. Application Data
(63) Continuation of application No. PCT/RU2023/000194, filed on Jun. 29, 2023.

(51) Int. Cl. G06F 40/49; G06F 40/51; G06F 40/58; G09B 5/02; G10L 15/00

(52) U.S. Cl. CPC G06F 40/49; G06F 40/51; G06F 40/58; G09B 5/02; G10L 15/005

(57) ABSTRACT

A computing device for translating words into a target language includes a computing module for identifying known words in a set of words that have a known translation into the target language, translating said known words into the target language to obtain a combined set of words, determining high-frequency unknown words in the target language in the combined set of words and forming language pairs based on the high-frequency unknown words and their corresponding translations into the target language, and a user interface module for enabling the user to translate the output word, wherein the computing module further checks the word translation for correctness and adds the language pair corresponding to the checked word to a vocabulary database if the indicated word translation is correct.

### CROSS REFERENCE TO RELATED APPLICATIONS

This application is a continuation of International (PCT) application No. PCT/RU2023/000194 filed on Jun. 29, 2023. The entire contents of which are incorporated herein by reference for all purposes.

### TECHNICAL FIELD

The present invention relates to a field of computing technology, and more particularly to computing devices used for translating words into a target language.

### BACKGROUND ART

Known in the art are various computing devices which can be used for translating words into a target language.

In particular, known in the art is a computing device for translating words into a target language as disclosed in U.S. Patent Application Publication No. 2003203343 (hereinafter US 2003203343) published on Oct. 30, 2003 (IPC: G06F 40/00, G09B 19/06, G09B 19/08). The computing device of US 2003203343 allows the user reading a familiar text in a language known to the user to learn words in the target language by translating some grammatical units (for example, words in the language known to the user) into the target language in the familiar text, wherein a number of words in the familiar text that are translated into the target language or a frequency of appearance of words in the familiar text that are translated into the target language gradually increases from the beginning of the familiar text to the end of the familiar text.

It is to note that the computing device disclosed in US 2003203343 allows the target language to be taught by outputting, by means of a display module of the computing device of US 2003203343, to the user a combination of phrases in a language known to the user that include known words having a translation into the target language, the translation being known to the user, and/or known words having unknown translation into the target language, and phrases in the target language that include known words in the target language and/or unknown words in the target language, thereby slowing down and complicating the process of translating words into a target language due to at least the following reasons: (1) the user is required to read, on the display module, the entire combined text simultaneously containing words in the language known to the user and words in the target language so as to obtain any educational effect in terms of new words in the target language as learned by the user; (2) the combined text read by the user needs to have a story to be known to the user so as to identify an approximate translation of a word or a phrase in the target language, the phrase being located next to words or phrases in the language known to the user or being located between words or phrases in the language known to the user on the display module of the computing device of US 2003203343; (3) the user does not receive the knowledge about the exact/correct translation of words or phrases provided in the target language in the text read by the user, the text being displayed on the display module of the computing device of US 2003203343, but can only make assumptions about their meaning in the language known to the user or about their exact/correct translation into the language known to the user, wherein the computing device of US 2003203343 does not allow the indicated translation into the language known to the user to be checked for correctness, the translation being assumed by the user in relation to words or phrases in the target language that are encountered by the user in the text displayed on the display module of the computing device of US 2003203343; and (4) the absence of any system in teaching words or phrases in the target language since the words or phrases in the target language as provided in the read text are not interconnected and not necessarily repeated, wherein the user attempts to grasp the meaning in the language known to the user or the translation into the language known to the user in relation to all consecutive words or phrases in the target language that are encountered in the read text displayed on the display module of the computing device of US 2003203343.

Thus, a main disadvantage of known computing devices for translating words into a target language, including the computing device for translating words into a target language as disclosed in US 2003203343, is in that their functional components used for translating words into a target language have a reduced life cycle due to increased operating loads and overheating problems.

The closest prior art is a computing device for translating words into a target language as disclosed in Korean Patent No. 102287181 (hereinafter KR 102287181) published on Aug. 6, 2021. The computing device disclosed in KR 102287181 comprises (i) a computing module for receiving a set of words in a known language, the set of words being input by a user, and for performing at least the following operations: (a) identifying known words in the set of words that have a known translation into the target language by comparing each word in the set of words with a user vocabulary database stored in a storage device accessible to the computing module and (b) allowing the set of words together with a partial translation thereof into the target language to be outputted to the user by using a display module; (ii) a user interface module for enabling the user to indicate a free field a translation into the target language for each word in the set of words, said word having unknown translation into the target language, wherein the computing module is further connected to the user interface module for receiving data on the indicated word translation from the user interface module and further configured to check said indicated word translation for correctness so as to allow a check result to be displayed.

In particular, in the computing device disclosed in KR 102287181, the above disadvantage is conditioned by the fact that all the set of words in the known language as received by the computing device and a partial translation of said set of words into the target language are simultaneously displayed, so that increased computing resources and memory resources are to be allocated by the computing device, thereby resulting in increased operating loads and overheating problems of corresponding functional components of the computing device and, therefore, reduced life cycle of the computing device.

Thus, known computing devices for translating words into a target language are to be further improved, in particular for extending a life cycle of the computing devices used for performing the process of translating words.

Consequently, a main technical problem to be solved by the present invention is to develop a computing device and a method of translating words into a target language that would at least partially eliminate at least the above-mentioned disadvantage of the known computing device, i.e. reduced life cycle of the computing device and functional components of the computing device that are used for translating words into the target language.

A further technical problem to be solved by the present invention is to increase a number of technical means used for translating words into the target language.

### SUMMARY OF THE INVENTION

An objective of the present invention is to develop a computing device and a method of translating words into a target language that would solve at least the above-mentioned main technical problem.

Another objective of the present invention is to develop new computing devices and a new method for translating words into the target language that would be alternatives to corresponding technical means known in the art.

To achieve any of the objectives of the present invention, as embodied and broadly described herein, in a first aspect of the present invention, there is provided a computing device for translating words into a target language, the computing device comprising: (i) a computing module for receiving a set of words in a known language and performing at least the following operations: (a) identifying known words in the received set of words that have a known translation into the target language by comparing each word in the received set of words with a user vocabulary database stored in a storage device accessible to the computing module, and (b) translating the identified known words in the received set of words into the target language to obtain a combined set of words, and (ii) a display module operatively coupled to the computing module for displaying the obtained combined set of words, wherein the computing module is further configured to perform at least the following operations: (c) determining high-frequency unknown words having unknown translation into the target language in the obtained combined set of words that have each a predetermined occurrence frequency, (d) forming language pairs to be learned by the user based on the determined high-frequency unknown words and their corresponding translations into the target language and (e) allowing a word from at least one of the formed language pairs to be outputted to the user, and said computing device further comprises (iii) a user interface module for enabling the user to indicate a translation of said output word, wherein the computing module is further operatively coupled to the user interface module to receive data on the indicated word translation, and wherein the computing module is further configured to check the indicated word translation for correctness and to add the language pair corresponding to the checked word to the user vocabulary database if the indicated word translation is correct.

To achieve any of the objectives of the present invention, as embodied and broadly described herein, in a second aspect of the present invention, there is provided a computing device for translating words into a target language, the computing device comprising: (i) a computing module for receiving a set of words in a known language and performing at least the following operations: (a) identifying known words in the received set of words that have a known translation into the target language by comparing each word in the received set of words with a user vocabulary database stored in a storage device accessible to the computing module, and (b) translating the identified known words in the received set of words into the target language so as to obtain a combined set of words, and (ii) a touch display module operatively coupled to the computing module for displaying the obtained combined set of words, wherein the computing module is further configured to perform at least the following operations: (c) determining high-frequency unknown words having unknown translation into the target language in the obtained combined set of words that have each a predetermined occurrence frequency, (d) forming language pairs to be learned by the user based on the determined high-frequency unknown words and their corresponding translations into the target language and (e) allowing a word from at least one of the formed language pairs to be outputted to the user, wherein the touch display module is further configured to enable the user to indicate a translation of said output word, and wherein the computing module is further configured to receive data on the indicated word translation from the touch display module, and wherein the computing module is further configured to check the indicated word translation for correctness and to add the language pair corresponding to the checked word to the user vocabulary database if the indicated word translation is correct.

To achieve any of the objectives of the present invention, as embodied and broadly described herein, in a third aspect of the present invention, there is provided a method of translating words into a target language, the method being performed on a computing device comprising a display module and including the following steps: (i) processing a set of words in a known language to identify known words in the set of words that have a known translation into the target language by comparing each word in the received set of words with a user vocabulary database stored in a storage device accessible to the computing module, (ii) translating the identified known words in the set of words into the target language to obtain a combined set of words, (iii) displaying, by means of the display module, the combined set of words, (iv) determining high-frequency unknown words having unknown translation into the target language in the obtained combined set of words that have each a predetermined occurrence frequency, (v) forming language pairs to be learned based on the determined high-frequency unknown words and their corresponding translations into the target language; (vi) storing the formed language pairs in the storage device; (vii) outputting a word from at least one of the formed language pairs to the user, (viii) enabling the user interface with the computing device for indicating, by the user, a translation for the output word, (ix) checking the indicated word translation for correctness, and (x) adding the language pair corresponding to the checked word to the user vocabulary database if the indicated word translation is correct.

The computing device according to the first or second aspect of the present invention and the method according to the third aspect of the present invention provide each a technical effect which is a reduced volume of computing resources and memory resources to be allocated by the computing device for performing the process of translating words into a target language. In particular, the volume of computing resources and memory resources to be allocated by the computing device for performing the process of translating words into a target language is reduced by outputting to the user only high-frequency unknown words having unknown translation into the target language in the obtained combined set of words that have each a pre-determined occurrence frequency, i.e. only a limited part of words having a translation into the target language that is absent in the user vocabulary database stored in a storage device accessible to the computing module and having each a pre-determined occurrence frequency. In other words, the computing device used in the first aspect of the present invention, second aspect of the present invention and the third aspect of the present invention outputs to the user a limited part of the originally received set of words, namely only said high-frequency unknown words, but not all the words from the originally received set of words.

Moreover, the reduction of the volume of computing resources and memory resources to be allocated by the computing device for performing the process of translating words into a target language is also conditioned by the fact that the computing device, when used again in relation to the same or another set of words, will output to the user lower number of words from the set of words for enabling the user to indicate their translations, in particular due to updated user vocabulary database used by the computing device that is supplemented by new language pairs during previous operation cycles of the computing device. In other words, the adding of one or more new language pairs to the user vocabulary database as a result of each previous operation cycle of the computing device substantially increases a number of words having known translation and, therefore, reduces a number of words to be checked when determining high-frequency words, thereby reducing a number of outputted words from the formed language pairs corresponding to said high-frequency words for enabling the user to indicate their translation into the target language and, therefore, further saving computing resources and memory resources to be allocated by the computing device for performing the above-described separate operations during each subsequent operation cycle of the computing device.

### BRIEF DESCRIPTION OF THE DRAWINGS

The accompanying drawings, which are provided for ensuring a better understanding of the essence of the present invention, constitute part of the present document and are included in it for illustrating the below-described variants of implementation and aspects of the present invention. The accompanying drawings in combination with the below description serve for explaining the essence of the present invention. On the drawings:

FIG. 1 illustrates a system for teaching a user a target language to be learned by the user, comprising a computing device for teaching a user a target language to be learned by the user according to the first aspect of the present invention;

FIG. 2 illustrates a system for teaching a user a target language to be learned by the user, comprising a computing device for teaching a user a target language to be learned by the user according to the second aspect of the present invention;

FIG. 3 illustrates a block diagram, illustrating the main operations of the method of teaching a user a target language to be learned by the user according to the third aspect of the present invention.

### DETAILED DESCRIPTION OF THE INVENTION

Below are described some examples of possible embodiments of the present invention, wherein it should not be considered that the below description defines or limits the volume of the present invention.

All specific examples, provided in the present document, or at least a part of them, as well as corresponding word expressions (“for example”, “such as”, “in particular” or similar), essentially are used for improving the understanding of the essence of the present invention and for ensuring completeness of disclosure of the present invention, however these word expressions do not impose any limitations on the embodiments of the present invention, for the description of which they are used in the present document, in particular do not limit practical embodiments of elements, components, parts, units, modules, blocks, devices, means and/or similar, used for disclosure of features of the construction and functioning of the present invention.

### System for Teaching a User a Target Language to Be Learned by the User

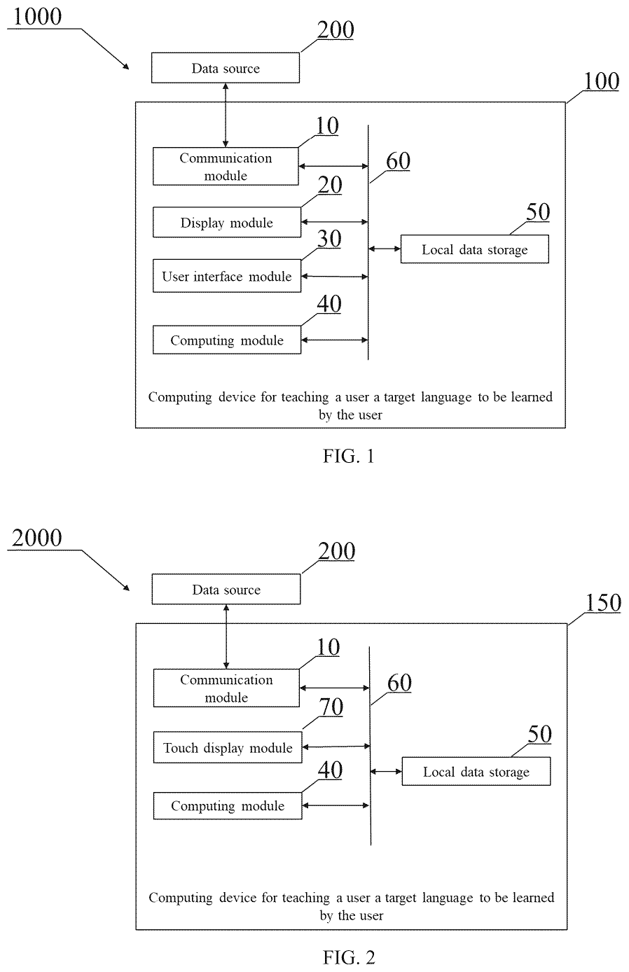

With reference to FIG. 1, there is shown one of the embodiments of the system 1000 for teaching a user a target language to be learned by the user, which comprises the user computing device 100 for teaching a user a target language to be learned by the user according to the first aspect of the present invention and the data source 200, operatively coupled via a wired or wireless connection for data exchange with the computing device 100, wherein the computing device 100 is pre-programmed or configured for identification of flows of data from the data source 200 on the basis of unique identifiers, contained in the flows of data and preliminarily known to the computing device 100.

It is to note that the wireless connection between the computing device 100 and the data source 200 can be implemented using, for example, the Internet, a cellular network, an Ethernet network, an LTE network, a WiFi network, a 3G network, a 4G network, a 5G network or another suitable network of wireless communication, known in the art, and the wire connection between the computing device 100 and the data source 200 can be implemented using, for example, a digital subscriber line of communication (DSL), a telephone line, a coaxial cable, a twisted pair, a fiber-optic cable or another suitable physical connection, known in the art.

In one of the embodiments of the present invention, the data source 200 can be, for example, a smartphone, a cellular telephone, a tablet, a laptop, a netbook, an electronic book, a stationary computer, a server or a similar computing device configured to establish a wired and/or wireless connection with the computing device 100 to transmit to it at least one set of words in a known language (i.e., at least one text from words in a known language), which can subsequently be used in the computing device 100 to carry out the process of teaching a target language to the user, and/or at least some of the below-described data, which can be used during operation of the computing device 100.

It is to note that the known language can be any natural or artificially created language in the world, which is known to the user and which the user intends to use to learn the target language, and the target language can represent any other existing in the world natural or artificially created language, different from the indicated known language, wherein the target language can be completely unknown to the indicated user or partially known to the indicated user before the beginning of the process of teaching the indicated target language by the user with the use of the computing device 100 according to the present invention, described in the present document. For example, the known language can represent the Russian language, the Belarusian or the Ukrainian language, and the target language can represent the English language, the German language, the French language, the Spanish language, the Chinese language, the Japanese language, the Korean language, the Italian language or similar.

In another embodiment of the present invention, the data source 200 can be a remote data source, such as, for example, a remote computing device, a cloud storage of data, a server, a host, a domain, a database, a program, a site or another remote storage of data. Such a remote source of data can store at least one set of words in a known language (i.e., at least one text from words in a known language), which can subsequently be used in the computing device 100 to carry out the process of teaching a target language to the user, and/or at least some of the below-described data, which can be used during operation of the computing device 100, for long-term or temporary storage and can enable the transfer of said set of words in a known language and/or the indicated working data into the computing device 100 upon establishment of a wired and/or wireless connection between them.

Thus, the computing device 100 can be configured to establish a wired or wireless connection with at least one data source 200 or to connect to such a data source 200 to receive from it at least one stored set of words in a known language (i.e., at least one text from words in a known language) or at least their part and/or to receive from it the above-described working data or at least a part of these working data, wherein the indicated transmitted data can be transmitted by the data source 200 to the computing device 100 in response to a request of the computing device 100.

In some other embodiment of the present invention, sets of words in a known language (i.e., texts in a known language) and/or above-described working data, stored in the data source 200, can be automatically transmitted or sent to the computing device 100 (e.g., in real time in the form of a summary packet of data, containing at least one set of words in a known language and/or at least a part of above-described working data, or in the form of separate packets of data, each of which contains at least one set of words in a known language and/or at least a part of above-described working data) and subsequently stored, for example, in the local data storage 50 in the computing device 100.

In yet another embodiment of the present invention, the data source 200 can be implemented as a removable machine-readable data carrier for storing at least one set of words in a known language and/or at least a part of above-described working data in a machine-readable form, in particular can represent (a) an external hard disk, a magnetic disk, which can be inserted into a magnetic disk drive of the computing device 100 for reading and writing, (b) an optical disk, such as, for example, a CD-disk, a DVD-disk, a BD-disk or other known in the art optical carriers of information, which can be inserted into a corresponding optical drive for reading and writing on removable optical disks of the computing device 100, (c) a solid-state drive, (d) a flash-card, (e) a digital disk or similar.

In some other embodiments of the present invention, the data source 200 can be implemented as a local storage device, integrated or built into the computing device 100 for storing at least one set of words in a known language and/or at least a part of above-described working data, in particular can represent a hard disk for reading and writing of data.

It should also be noted that the data source 200 is shown in FIG. 1 by way of example only. Thus, it should not be considered that a possible realization of the system 1000 for teaching a user a target language to be learned by the user is limited by only one data source 200, wherein it is obvious for one skilled in the art that the system 1000 for teaching a user a target language to be learned by the user can contain two or more sources of data, each similar to the data source 200 and each configured to exchange data with the user computing device 100 for teaching a user a target language to be learned by the user.

In some embodiments of the present invention, the system 1000 for teaching a user a target language to be learned by the user can comprise at least two computing devices, each similar to the below-described computing device 100 for teaching a user a target language to be learned by the user, wherein the below-described functional possibilities of the computing device 100 can be divided in any necessary or proper manner between the indicated at least two computing devices, each of which can be, for example, a separate personal computer of general purpose, a smartphone, a laptop, a tablet, a netbook or similar.

### User Computing Device for Teaching a User a Target Language to be Learned by the User

As shown in FIG. 1, the computing device 100 comprises a connection module 10, a display module 20, a user interface module 30, a computing module 40 and a local data storage 50, which are configured to exchange data with each other via a connection bus 60, to which they are all connected. The connection module 10, the display module 20, the user interface module 30, the computing module 40, the local data storage 50 and the connection bus 60 are implemented in a single housing.

The computing device 100, shown in FIG. 1, is a software-hardware complex that can be implemented, for example, as an ordinary smartphone, the structure and functions of which are well known to a person skilled in the art. Furthermore, the computing device 100 can be implemented as a mobile phone, a tablet, a laptop, an all-in-one computer, a netbook, smart glasses, or another electronic computing device suitable for performing the tasks described herein in relation to the computing device 100. Furthermore, the computing device 100 can be implemented as a general-purpose computer having the structure described below, which is well known to a person skilled in the art.

In particular, a general-purpose computer, which can embody the computing device 100 described herein, typically comprises a central processor, a system memory, and a system bus that interconnects various system components, including the memory, with the central processor. The system bus in such a general-purpose computer may include a memory bus and a memory bus controller, a peripheral bus, and a local bus, which may be configured to interface with any other bus architecture. The system memory includes read-only memory (ROM) and random access memory (RAM). A basic input/output system (BIOS), containing fundamental routines that facilitate the transfer of information between elements of the general-purpose computer (e.g., during the operating system bootstrap from ROM), is stored in the ROM. Furthermore, the general-purpose computer comprises a hard disk drive for reading and writing data, a magnetic disk drive for reading from or writing to removable magnetic disks, and an optical disk drive for reading from or writing to removable optical media such as CD-ROM, DVD-ROM, or other optical disks. Other types of machine-readable storage media, such as solid-state drives, flash cards, digital versatile disks, or the like, configured to store data in a machine-readable form, may also be used and are connected to the system bus via an appropriate controller. The hard disk drive, the magnetic disk drive, and the optical disk drive are connected to the system bus via a hard disk drive interface, a magnetic disk drive interface, and an optical disk drive interface, respectively. The drives and their associated machine-readable media provide non-volatile storage of computer-executable instructions, data structures, program modules, and other data for the general-purpose computer. The general-purpose computer employs a file system in which the operating system, additional software applications, other program modules, and program data are stored. A user may enter commands and information into the general-purpose computer through known input devices, such as a keyboard, a pointing device (e.g., a mouse), a microphone, a joystick, a game pad, a scanner, or the like. These input devices are typically connected to the general-purpose computer through a serial port interface that is coupled to the system bus, but may be connected by other interfaces, such as a parallel port, a game port, or a universal serial bus (USB). A monitor or another type of display device is also connected to the system bus via an interface, such as a video adapter. In addition to the monitor, the personal computer may be equipped with other peripheral output devices, such as speakers or a printer. The general-purpose computer is capable of operating in a networked environment and may use a network connection to connect to one or more remote computers. Such network connections may constitute a local area network (LAN) or a wide area network (WAN). Such networks are commonly used in corporate computer networks and company intranets, and they generally provide access to the Internet. In a LAN or WAN environment, the general-purpose computer is connected to the local network through a network adapter or a network interface. When used in a networking environment, the general-purpose computer may employ a modem, a network card, an adapter, or other means for establishing a connection to a wide area network, such as the Internet. These connection means are connected to the system bus via the serial port interface. It is to note that machine-readable instructions, accessible by the central processor of the general-purpose computer, may reside in the ROM of the general-purpose computer or on any of the aforementioned machine-readable storage media. Execution of these machine-readable instructions by the general-purpose computer may cause its central processor to perform various procedures or operations described below in this document.

In one embodiment of the present invention, the computing device 100 for teaching a user a target language to be learned by the user can be implemented as a single computer server, for example, a “Dell™ PowerEdge™” server running the “Linux Ubuntu Server 18.04” or “Linux Ubuntu Server 20.04” operating system.

In other embodiments, the computing device 100 for teaching a user a target language to be learned by the user can be implemented as a combination of hardware, software, and/or a software-hardware complex suitable for performing the tasks described herein in relation to the computing device 100.

In one embodiment of the present invention, the computing device 100 may also comprise a separate analysis module (not shown) for analyzing input data (also referred to as a data pre-processing module, filtering module, identification module, scanning module, recognition module, or the like). The analysis module is connected to the connection module 10 via the connection bus 60 to receive from the connection module 10 at least one set of words in a known language (i.e., at least one text in a known language) and/or the above-described working data, which is transmitted to the computing device 100 from the data source 200 in the form of a corresponding aggregated data packet/stream or a corresponding set of data packets/streams associated with at least the data source 200 using a unique data source identifier. In particular, it is to note that the data stream received by the connection module 10 from the data source 200 and relating to a specific set of words in a known language contains not only digital data of said set of words in a known language (i.e., digital data of the text in a known language) and a unique text identifier, but also identification data of the data stream itself, describing the transmitted data stream (e.g., the date and time of transmission, sender identification data such as a unique data source identifier, recipient identification data such as a unique computing device identifier, and/or other necessary attributes of such a transmitted data stream enabling its identification). Furthermore, the above-described analysis module is pre-programmed or configured to process various data streams received by the connection module 10 to identify a data stream relating, for example, to sets of words in a known language (i.e., to texts in a known language) from the data source 200 (in particular, by detecting a match between the stream identification data and one of the unique data source identifiers known to the analysis module and stored, for example, in the local data storage 50 to which such an analysis module can be connected via the connection bus 60) and to extract from it the set of words in a known language. Furthermore, such an analysis module can be additionally configured to (i) pre-process each set of words in a known language (i.e., each text in a known language) extracted from the data stream originating from the data source 200, enabling recognition of said set of words in a known language (i.e., the received text in a known language) to separate each individual word in a known language from said set of words in a known language or to divide said set of words in a known language into individual words in a known language.

In yet another embodiment of the present invention, the functions of the analysis module described above—including those functions disclosed in the aforementioned additional embodiments—may be implemented alternatively by the computing module 40 (described below). The computing module 40 is connected to the connection module 10 via the connection bus 60 for this purpose.

In another embodiment of the present invention, the functions of the analysis module described above—including those disclosed in the additional embodiments—may be performed by the data source 200 itself, in some of its configurations. This is applicable in those configurations where the data source 200 possesses data processing capabilities.

### Local Data Storage

The local data storage 50, shown in FIG. 1 as part of the computing device 100, is intended for storing executable instructions that can control the operation of at least the connection module 10, the display module 20, the user interface module 30, and the computing module 40. It is also intended for storing various data (working or system data) used during the operation of the computing device 100, in particular: (i) data on words in the target language known to the user, which can be stored in the form of formed language pairs, each of which contains a word in a known language and its corresponding (i.e., tied) translation into the target language, which translation is known to the user; (ii) data on available sets of words in a known language (i.e., texts from words in a known language), to each of which a unique text identifier is assigned; (iii) data on the intermediate results of implementing each of the below-described stages of the method of teaching the target language to the user using a specific set of words in a known language (i.e., a specific text from words in a known language), performed with the use of the computing device 100 described herein, and/or similar data.

In one embodiment of the present invention, where data on sets of words in a known language (i.e., texts from words in a known language) that can be used in the operation of the computing device 100 is stored in the local data storage 50, each word in a known language within each set of words (i.e., within each available text) can be assigned a unique identifier for a word in the known language. Furthermore, it can also be assigned an identifier of a corresponding word in the target language for which the translation is known to the user, and data on which can also be stored in the local data storage 50. It is to note that in such an embodiment, any specific set of words in a known language (i.e., any specific text from the available texts), the data for which is stored in the local data storage 50, may contain at least two or even many identical words in the known language, and these identical words will share one and the same unique identifier for a word in the known language.

The local data storage 50 can also at least temporarily store the following interface data: (i) interface data for displaying sets of words in a known language (i.e., texts from words in a known language) or portions thereof; (ii) interface data for the sequential visual highlighting of one of the displayed words in the known language; (iii) interface data for displaying instructions or hints related to words from the language pairs to be learned, the translation of which must be indicated by the user when each of these words is output to the user; (iv) interface data for displaying instructions or hints related to the means for the user to indicate a proposed translation for the words output from the language pairs to be learned; and (v) other interface data necessary for carrying out the below-described operations of the method of teaching the target language to the user, performed by the computing device 100 using a specific set of words in a known language (i.e., a specific text from words in a known language).

Furthermore, the local data storage 50 can store auxiliary data, such as, for example, algorithm data for the automatic recognition or identification, within a specific set of words in a known language (i.e., within a specific text from words in a known language), of those words in the known language whose translation into the target language is known to the user. It can also store algorithm data for the automatic determination of the frequency of appearance, within a set of words in a known language displayed to the user, of those words in the known language that have a translation into the target language not yet known to the user, and/or similar data.

In some embodiments of the present invention, the local data storage 50 in the computing device 100 can contain one or several databases, each configured to store at least one separate group or set of data from the above-enumerated groups, used during the operation of the computing device 100. For example, these may include: an interface data database; a database of available sets of words in a known language (i.e., texts from words in a known language); an auxiliary data database; a database of words in the target language with known translations into the known language; a database of language pairs to be learned; a database of results from checking the correctness of translations indicated by the user for words in a known language; and/or other databases for storing other aforementioned data or other data obvious to a person skilled in the art, used during the operation of the computing device 100.

In other embodiments of the present invention, the computing device 100 can use at least one separate remote data storage (not shown) to store at least a part, or all, of the above-described groups of data used during its operation. This includes, in particular, interface data, data on available sets of words in a known language (or texts from words in a known language), auxiliary data, data on words in the target language with known translations into the known language, data on language pairs to be learned, data on the results of checking the correctness of translations indicated by the user for words in a known language, and/or other data used during the operation of the computing device 100. The display module 20, the user interface module 30, and/or the computing module 40 can access this separate remote data storage using the connection module 10. The connection module 10 is connected within the computing device 100 to the connection bus 60 and is configured to connect to separate remote data storages via wired and/or wireless means.

In some other embodiments of the present invention, the computing device 100 can contain at least one local data storage and at least one remote data storage (not shown), each intended to store at least one group of data from the above-described groups used during the operation of the computing device 100. The local data storages can each be connected to the connection module 10, the display module 20, the user interface module 30, and/or the computing module 40 using the connection bus 60. The remote data storages can each be connected, via wired and/or wireless means, to the display module 20, the user interface module 30, and/or the computing module 40 using the connection module 10, which is connected within the computing device 100 to the connection bus 60. Thus, for example, one possible embodiment is where the computing device 100 contains a sole local data storage 50 (storing, for instance, exclusively interface data) and several remote data storages for other groups of data used during its operation. These remote storages could include: a remote data storage for data on available sets of words in a known language (or texts from words in a known language); a remote data storage for auxiliary data; a remote data storage for data on words in the target language with known translations into the known language; a remote data storage for data on language pairs to be learned; a remote data storage for data on the results of checking the correctness of translations indicated by the user for words in a known language; and/or a remote data storage for other data used during the operation of the computing device 100.

In one of the embodiments of the present invention, at least one of the above-enumerated groups of data used during the operation of the computing device 100—in particular, interface data, data on available sets of words in a known language (or texts from words in a known language), auxiliary data, data on words in the target language with known translations into the known language, data on language pairs to be learned, data on the results of checking the correctness of translations indicated by the user for words in a known language, and/or other operational data—can be saved in a corresponding separate local data storage (not shown). This separate storage is different from the local data storage 50 and is connected, via the connection bus 60, to the connection module 10, the display module 20, the user interface module 30, and/or the computing module 40. These modules, in turn, can each be further configured to connect, via the connection bus 60, to any such separate local data storage to extract the necessary data from them.

The local data storage 50 can be implemented, for example, as one or more physical machine-readable media for long-term data storage, as known in the art. In some embodiments of the present invention, the local data storage 50 can be implemented using a single physical device (for example, an SSD drive, flash memory, or the like). In other embodiments, the local data storage 50 can be implemented using two or more such storage devices, as known in the art.

### Connection Module

The connection module 10, shown in FIG. 1 as part of the computing device 100, is configured to establish a wired and/or wireless connection with the data source 200 for data exchange upon establishing a communication channel between them.

The connection module 10 can be used to transfer data packets or data streams from the computing device 100 to the data source 200. These packets or streams have a predetermined description format known to the data source 200. Conversely, the module can be used to receive data packets or data streams from the data source 200, which have a predetermined description format known to the computing device 100. Furthermore, the connection module 10 can be used to direct various requests (including system requests) or commands from the computing device 100 to the data source 200, and also to receive from the data source 200 various requests, commands, system responses/confirmations, and/or requested data.

In particular, in the present invention, the connection module 10 essentially enables the computing device 100 to obtain from the data source 200 a set of words in a known language (i.e., a text composed of words in a known language). This set is contained within a data stream directed from the data source 200 to the computing device 100 via a wired or wireless communication line.

In one embodiment of the present invention, the connection module 10 can be connected to the data source 200 via a wired method, for example, using a coaxial cable, twisted pair, fiber-optic cable, or another physical connection, enabling the computing device 100 to obtain from it a set of words in a known language (i.e., a text from words in a known language). In this embodiment, the connection module 10 can be implemented as a network adapter, equipped with the necessary connectors for attaching physical cables of the required types, depending on the types of physical connections used to establish the connection with the data source 200.

In yet another embodiment, the connection module 10 can be connected to the data source 200 via a wireless method, for example using a connection line based on “WiFi” technology, a connection line based on “3G”/“4G”/“5G” technology, a connection line based on “LTE” technology, or the like. In this embodiment, the connection module 10 can be implemented as a network adapter in the form of a WiFi adapter, a 3G/4G/5G adapter, an LTE adapter, or another wireless connection adapter, depending on the type of wireless connection line used to establish the connection between the computing device 100 and the data source 200.

The connection module 10 in the computing device 100 can also be a known communication device, such as a transmitter, a receiver, a transceiver, a modem, and/or a network interface card (NIC) for data exchange with external devices of any type over a wired or wireless communication network. For example, this can be achieved using a network connection based on the “Ethernet” standard, a digital subscriber line (DSL), a telephone line, a coaxial cable, a cellular telephone system, or the like.

In the above-described embodiments where all groups of data used during the operation of the computing device 100—in particular during the operation of each functional module constituting the computing device 100—or at least a part thereof, are stored in at least one separate remote data storage, the connection module 10 can be configured to connect to said at least one remote data storage. This enables the computing device 100 to obtain from it the necessary data used during its operation, for example, the aforementioned interface data or data on available sets of words in a known language (i.e., data on texts from words in a known language).

In some embodiments, the connection module 10 in the computing device 100 can be further configured to establish a connection with at least one remote data source that stores at least some data from the groups of data used during the operation of the computing device 100, in particular during the operation of each functional module constituting the computing device 100. Alternatively, it can be configured to connect to such a data source to enable the computing device 100 to obtain from it data necessary for achieving the purpose of the computing device 100—namely, teaching the target language to the user—or for fulfilling the functional purpose of the corresponding functional module. Examples of such a remote data source include a remote computing device, a cloud data storage, a server, a host, a domain, a database, a program, a website, or the like.

### Display Module

The display module 20, shown in FIG. 1 as part of the computing device 100, is connected via the connection bus 60 to the computing module 40 (described below) for data exchange and to the connection module 10 for data exchange. The computing module 40 is essentially configured to control the operation of the display module 20 using a graphics processor or a video card (not shown).

The display module 20 can be implemented, for example, as a display known in the art, such as an OLED display, an IPS display, a TFT display, an LCD display, an AMOLED display, a P-OLED display, a QLED display, or the like. In one embodiment of the present invention, the display module 20 can support touch screen technology or MultiTouch technology; that is, it can be a touch display module or a touch display.

Thus, the display module 20 essentially simultaneously receives, via the connection bus 60, a set of words in a known language (i.e., a text composed of words in a known language) and at least some of the above-described interface data. It enables the subsequent display of this received data to the user in real time. This allows the user to see on the display module 20, in a structured form, either a portion of the words in the known language from said set (i.e., the text), depending on the visible display area characteristic of the display module 20 (i.e., essentially depending on the size of the display's working area used for data visualization), or all words in the known language from said set (i.e., the entire text).

It is to note that the initial display of a set of words in a known language (i.e., an initial text composed of words in a known language), or a part thereof, on the display module 20 allows the user to decide whether to continue learning the target language using that specific displayed set of words, or whether another set of words in a known language—whose theme or content is more understandable and/or more relevant to the user—should be used instead. The replacement of an already displayed set of words in a known language with another set for its subsequent display on the display module 20 can be performed by the user using standard input/output means of the computing device 100, or via the capability of the display module 20 to register touch input (piezoelectric effect) if the display module 20 is implemented as a touch display module.

In one embodiment of the present invention, the computing module 40 can enable the output of data onto the display module 20 from the local data storage 50 (or, depending on the embodiment—as described above—from a separate local data storage via the connection bus 60 and/or from a remote data storage via the connection module 10, which is connected to the connection bus 60). This data includes, in particular, a specific set of words in a known language (i.e., a specific text from words in a known language). This set can be automatically requested by the computing module 40 upon switching on or starting the computing device 100, resulting in its at least partial output on the display module 20 (i.e., at least partial display) via the connection bus 60. Alternatively, it can be selected by the user using standard input/output means of the computing device 100 during its operation, also resulting in its subsequent at least partial output on the display module 20 via the connection bus 60. Furthermore, in this embodiment, the computing module 40 also enables the output onto the display module 20 of the aforementioned interface data from the local data storage 50 (or, as described, from a separate local or remote data storage). The computing module 40 has or can obtain access to this data via the connection bus 60.

It is to note that if only one portion of a specific set of words in a known language is displayed on the display module 20 (this set being used by the computing device 100 within the given or current cycle of teaching the target language to the user), the display module 20 enables the display of each subsequent remaining portion of said set that fits within the working display area of the display module 20.

Furthermore, the display module 20 is also configured to repeatedly display—under the control of the computing module 40—the same or another set of words in a known language. This repeated display can occur, in particular, within a subsequent cycle of teaching the target language to the user, which may constitute a complete or partial repetition of the current teaching cycle. Such a cycle is considered complete after the display module 20 has displayed the set, and the cycle can be ended by the user using standard input/output means of the computing device 100, or automatically upon meeting a predefined condition (for example, upon expiration of a set time period, after outputting to the user words from a predetermined number of language pairs to be learned for the user to indicate their translation, or similar).

In one embodiment of the present invention, the display module 20 may also forgo displaying the initial set of words in a known language. Instead, it can display the combined set of words (described below), which is formed or obtained by processing the initial set by the computing module 40. This combined set contains: (i) words in the known language whose translation into the target language is not yet known to the user, and (ii) words translated into the target language that correspond to words from the initial set whose translation into the target language is known to the user. These translated words are essentially obtained by replacing the known words in the initial set with their translations into the target language.

### User Interface Module

The user interface module 30, shown in FIG. 1 as part of the computing device 100, is connected via the connection bus 60 to the computing module 40 (described below) and to the display module 20 for data exchange.

The user interface module 30 can be implemented, for example, as any suitable input device known in the art, such as a keyboard, a pointing device (e.g., a mouse), a microphone, a camera, a joystick, a game pad, or any other suitable input device.

The user interface module 30 is configured to enable the user to indicate a translation into the target language for each word in a known language that is output to the user. Such a word corresponds to one of the language pairs to be learned by the user, which are formed by the computing module 40 as described below. Alternatively, the module is configured to enable the user to indicate a translation into the known language for each word in the target language that is output to the user, which also corresponds to one of such language pairs.

For example, if the user interface module 30 is implemented as a keyboard, the user can enter—using the keyboard keys—the translation into the target language for a word in a known language. This word may be displayed on the display module 20 or output to the user via a speaker of the computing device 100 as an audio signal. Alternatively, in this example, the user can enter—using the keyboard keys—the translation into the known language for a word in the target language, which likewise may be displayed or provided as an audio signal.

In one embodiment of the present invention where the computing device 100 lacks a separate user interface module 30 and the display module 20 is implemented as a touch display module, the user can enter the translation. This is done by using on-screen buttons or keys of an on-screen keyboard, pressed with the user's fingers, to input the translation into the target language for a word in a known language. The word may be displayed on the display module 20 or provided as an audio signal via a speaker. Alternatively, in this embodiment, the user can similarly use the on-screen interface to enter the translation into the known language for a word in the target language (which may also be displayed or provided as audio).

In the case where the user interface module 30 is implemented in the form of a pointing device of the “mouse” type, the user can enter—by means of the keys of an on-screen keyboard, pressed with the help of the indicated pointing device—the translation into the target language for a word in a known language. This word can be displayed on the display module 20 or can be output to the user, by means of a speaker of the computing device 100, in the form of a sound signal. As an alternative in this embodiment of the present invention, the user can enter—by means of the keys of the on-screen keyboard, pressed with the help of the pointing device of the “mouse” type—the translation into the known language for a word in the target language, which can be displayed on the display module 20 or can be output to the user, by means of the speaker of the computing device 100, in the form of a sound signal.

In the case where the user interface module 30 is implemented in the form of a camera, the user can enter the translation into the target language for a word in a known language—which can be displayed on the display module 20 or output to the user by means of a speaker of the computing device 100 in the form of a sound signal—by way of using predefined gestures. These gestures must be shown by the user (for example, with the help of the fingers or the hands themselves) and must fall into the field of view of the indicated camera. In such an embodiment of the present invention, the camera must capture images in a continuous mode or in real time, wherein the image captured by the camera—containing the body of the user or a part thereof (i.e., the fingers or hands of the user)—must be directed or transmitted by the indicated camera to the computing module 40 for its subsequent processing. This processing is performed, in particular, to establish whether the captured image contains a gesture corresponding to one of the predefined gestures known to the computing module 40, each of which is associated with one of a set of letters of the target language alphabet, one of a set of syllables of the target language alphabet, or one of a set of words of the target language. As an alternative, the user can similarly use the camera of the computing device 100 (in the form of which the user interface module 30 can be implemented) to enter the translation into the known language for a word in the target language, which can be displayed on the display module 20 or output to the user by means of the speaker of the computing device 100 in the form of a sound signal. It is to note that any predefined conditional signals of the user, demonstrated within the field of view of the indicated camera, can similarly be used—for example, predefined movements or positions of the user's body or its parts, predefined movements or positions of the user's lips, predefined movements or blinks of the eyes, and the like.

If the user interface module 30 is implemented as a microphone, the user can enter the translation into the target language for a word in a known language (displayed or output as audio) by pronouncing it. The user's spoken translation must be captured by the microphone in real time. The captured audio signal is then sent by the microphone to the computing module 40 as a stream of digital data for subsequent processing. This processing specifically involves the extraction of the word translation from said digital data stream by the computing module 40. It is to note that the user interface module 30 can be used by the user not only to indicate the translation of a word output to the user (a word corresponding to one of the language pairs to be learned, formed as a result of the below-described processing operations performed by the computing module 40 on at least one set of words in a known language). It can also be used during the below-described testing of the user's vocabulary. This testing may be required to form a database corresponding to the user's vocabulary, which is stored in the local data storage 50 (or, depending on the embodiment—as described above—in a separate local data storage via the connection bus 60 and/or in the data source 200 via the connection module 10). The computing module 40 (described below) has or can obtain access to this database via the connection bus 60.

### Computing Module

The computing module 40, shown in FIG. 1 as part of the computing device 100, is connected via the connection bus 60 to the connection module 10, the display module 20, the user interface module 30, and the local data storage 50 for data exchange.

The computing module 40 is configured to perform the below-described processing operations on a specific set of words in a known language (i.e., a specific text composed of words in a known language) that is accessible to the computing device 100 and displayed by the display module 20. The computing module 40 can access said set of words in a known language for processing by either: extracting it via the connection bus 60 from the local data storage 50 (or, depending on the embodiment described herein, from a separate local data storage using the connection bus 60); or receiving it via the connection module 10 from the data source 200 (e.g., from a remote data storage) upon establishing a connection channel between the computing device 100 and the data source 200. Thus, the data pertaining to a specific set of words in a known language (i.e., the data for a specific text composed of words in a known language) to be processed by the computing module 40 essentially correspond to the specific set of words in a known language initially displayed on the display module 20. It is to note that the partial or complete display of a set of words in a known language by the display module 20 and the processing of this set by the computing module 40 occur essentially simultaneously or in parallel. This follows the extraction of said set of words in a known language from the local data storage 50 by the computing module 40, or its reception from the data source 200 via the connection module 10 upon establishing a connection channel between the computing device 100 and the data source 200. In one embodiment of the present invention, the computing resources of the computing module 40 can be initially directed essentially entirely towards operations related to displaying a specific set of words in a known language via the display module 20, and subsequently directed towards performing the below-described operations related to processing that set of words by the computing module 40.

The computing module 40 can be implemented, for example, as a separate processor, such as a general-purpose processor, a special-purpose processor, and/or the like. Such a processor may have either a single computing core or many jointly functioning computing cores.

The computing module 40 is configured to control the operation of the display module 20 through a graphics processor or a video card. This enables: the display on the display module 20 of a set of words in a known language (i.e., a text composed of words in a known language) in a structured form; and the display on the display module 20 of the aforementioned interface data. This interface data includes: (i) data for displaying sets of words in a known language (i.e., texts in a known language) or portions thereof, and data for outputting words from the language pairs to be learned to the user, the translation of which the user must indicate; (ii) data for displaying instructions or hints related to the user indicating translations of words output from the language pairs to be learned, and/or related to the means for the user to indicate such translations; (iii) data for displaying the result of checking the correctness of the translations indicated by the user for words output from the language pairs to be learned; and (iv) other interface data necessary for fulfilling the purpose of the computing device 100.

For teaching the target language to the user, the computing module 40 enables the performance of the below-described operations on the data pertaining to a set of words in a known language. This data corresponds to the set of words in a known language initially displayed on the display module 20.

In particular, the computing module 40 identifies known words within the processed set of words in a known language—that is, words that have a translation into the target language which is known to the user.

For the initial revealing or determination of words in a known language, the translation of which into the target language is known to the user, or for the initial revealing or determination of words in the target language, the translation of which into the known language is known to the user, the computing device 100 can be used for conducting preliminary testing of the vocabulary reserve of the user. In accordance with this, the user can be proposed to indicate, for each or at least one of a preliminarily set group of words (for example, the most common or basic words) in a known language displayed by means of the display module 20, the known translation into the target language. Alternatively, the user can be proposed to indicate, for each or at least one of a preliminarily set group of words (for example, the most common or basic words) in the target language displayed by means of the display module 20, the known translation into the known language. This will allow the formation of a database that corresponds to the vocabulary reserve of the user and that can contain known language pairs. Each such pair is formed from a word in a known language and the corresponding word in the target language, and is formed as a result of the user correctly indicating the translation of the word during the preliminary testing of the vocabulary reserve.

It is to note that the database corresponding to the vocabulary reserve of the user, formed in the above-described manner as a result of conducting one or more cycles of the preliminary testing, can be saved in the local data storage 50 (depending on the embodiment, as described above in the present document, in a separate local data storage with the use of the connection bus 60 and/or in the data source 200 with the use of the connection module 10, which is connected to the connection bus 60). The computing module 40 has access or can obtain access to this storage by means of the connection bus 60.

It should also be noted that for checking the correctness of the translation indicated by the user during the preliminary testing of the vocabulary reserve, a vocabulary database is used. This database is preliminarily saved in the local data storage 50 (depending on the embodiment, as described above, in a separate local data storage with the use of the connection bus 60 and/or in the data source 200 with the use of the connection module 10, connected to the connection bus 60). The computing module 40 has access or can obtain access to this database by means of the connection bus 60.

Thus, each translation of a word indicated by the user during the preliminary testing of the vocabulary reserve is compared, by means of the computing module 40, with the vocabulary database. This allows the determination of the correctness of the translation indicated by the user, or the determination of whether the user knows the correct translation of the word into the known language in the case of outputting this word to the user in the target language, or the correct translation of the word into the target language in the case of outputting this word to the user in a known language.

It is to note that for indicating the translation of the word during the preliminary testing of the vocabulary reserve, the user can use: the standard means of input-output of the computing device 100; an on-screen keyboard by means of the display module 20; the possibilities for registration by the display module 20 of the piezoelectric effect in the case where the display module 20 is executed in the form of a sensory display module; the possibilities of the computing device 100 for processing sound data corresponding to the voice input of the user, registered by means of a microphone of the computing device 100; and other suitable methods known in the art.

It should also be noted that for outputting a word to the user in a known language or in the target language, the translation of which the user must indicate during the preliminary testing of the vocabulary reserve, the display module 20, a speaker of the computing device 100, or similar means can be used.

In various embodiments of the present invention, the computing module 40 can ensure the possibility of conducting additional testing of the vocabulary reserve of the user, using the computing device 100, for replenishment of the vocabulary database saved in the local data storage 50. The indicated additional testing can be conducted, for example, after the user has indicated the translation for words output to the user, each corresponding to one of the below-described formed language pairs—in particular, after the user has indicated the translation for all such words output to the user, or only for a set quantity of words output to the user.

In some embodiments, the above-described database corresponding to the vocabulary reserve of the user can be preliminarily formed without the use of the computing device 100. In particular, it can be preliminarily saved in the local data storage 50 (depending on the embodiment, as described above in the present document, in a separate local data storage with the use of the connection bus 60 and/or in the data source 200 with the use of the connection module 10, which is connected to the connection bus 60). The computing module 40 has access or can obtain access to this storage by means of the connection bus 60.

In other embodiments of the present invention, the above-described database, which corresponds to the vocabulary reserve of the user, can represent the initial or original part of a personal dictionary for the target language. As a result of performing the operations described herein with the use of the computing device 100, the indicated personal dictionary for the target language can be replenished or expanded. This expansion utilizes each separately taken set of words in the target language processed by the computing module 40, or at least one of a multitude of such separately taken sets, each processed by the computing module 40.

Thus, for revealing words in the processed set of words in a known language that have a translation into the target language known to the user, the computing module 40 compares each word from the indicated set of words in a known language with the above-described database corresponding to the vocabulary reserve of the user. This comparison is made to reveal a coincidence, which indicates that the translation of the indicated word from the known language into the target language (or vice versa from the target language into the known language) is known to the user.

In the case where a word from the set of words in a known language being processed by the computing module 40 is discovered or revealed within the above-described database corresponding to the user's vocabulary reserve, the computing module 40 (which is connected to the display module 20 via the connection bus 60) issues the translation of that word into the target language onto the display module 20. This translation is extracted by the computing module 40 from the local data storage 50 (or, depending on the embodiment—as described above—from a separate local data storage via the connection bus 60 and/or from the data source 200 via the connection module 10, which is connected to the connection bus 60). The issuance ensures the replacement of the discovered word in the known language within the displayed set of words by its translation into the target language. In other words, instead of the word in the known language, the translation of this word into the target language is displayed on the display module 20. As a result of this replacement, the set of words displayed by the display module 20 may be restructured (for example, the display positions of words on the display module 20 may change) if the length of the word's translation into the target language differs from the length of the original word in the known language that was translated and replaced.

Thus, the words in a known language within the set of words in a known language displayed by the display module 20—those having a translation into the target language known to the user—end up being translated into the target language and displayed by the display module together with the remaining words in the known language, whose translation into the target language is not yet known to the user. In other words, as a result of performing such a partial translation operation, the display module 20 displays what is now a combined set of words (which may also be called a changed or transformed set of words). This combined set essentially represents a combination or mixture of: (i) words in the known language whose translation into the target language is unknown to the user at the given moment (i.e., based on the current state of the above-described database corresponding to the user's vocabulary reserve); and (ii) words in the target language, which are essentially the known translations into the target language for words from the initial set of words in a known language that was first displayed on the display module 20. These latter words (i.e., the words translated into the target language) are obtained by replacing the corresponding words in the known language—whose translation into the target language is known to the user—with their translations, using the aforementioned database corresponding to the user's vocabulary reserve.

Thus, the computing module 40 additionally ensures the possibility of displaying on the display module 20 the above-described combined set of words. This set corresponds to the initial set of words in a known language and is obtained as a result of the computing module 40 processing said initial set, ensuring the replacement of at least a part of the words in the known language by their translations into the target language.

In one embodiment of the present invention, the computing module 40 may not ensure the display on the display module 20 of the initial set of words in a known language, which it initially obtains for subsequent processing in the above-described manner to produce the combined set of words. Instead, it may ensure only the issuance of said combined set of words to the display module for display. Thus, in this embodiment, the computing module 40 can ensure the display on the display module 20 of only the combined set of words. This set is formed or obtained by processing the corresponding initial set of words in a known language and contains: (i) words in the known language whose translation into the target language is unknown to the user; and (ii) words translated into the target language that correspond to words from the initial set in the known language whose translation into the target language is known to the user. The translated words are essentially obtained by replacing the known words in the initial set (whose translation is known) with their translations into the target language, using the above-described database corresponding to the user's vocabulary reserve.

Furthermore, the computing module 40 is additionally configured to determine, among the words in a known language displayed on the display module 20, those words that each have a frequency of appearance meeting a set threshold value and that have a translation into the target language not yet known to the user. The set threshold value can essentially correspond to a frequency of appearance (i.e., the number of repetitions) of the same word in the set of words in a known language equal to two, three, four, five, six, seven, nine, ten, twenty, thirty, forty, fifty, sixty, seventy, ninety, one hundred, or more times. This threshold value can be preliminarily saved in the local data storage 50 (depending on the embodiment, as described above in the present document, in a separate local data storage with the use of the connection bus 60 and/or in the data source 200 with the use of the connection module 10, which is connected to the connection bus 60). The computing module 40 can obtain access to this storage by means of the connection bus 60.

In particular, the computing module 40 can reveal the most frequent words (i.e., those repeating with the greatest frequency) in the known language among those words in the set of words in a known language that were not replaced on the display module 20 by their translation into the target language.

In some embodiments of the present invention, the threshold value for revealing the most frequent words among the words in a known language displayed on the display module 20—those having a translation into the target language unknown to the user—can be: (i) a preliminarily set fixed value; (ii) a value automatically set by the computing module 40 as a result of its analysis of the set of words in the target language during the above-described processing of the indicated set of words in a known language; (iii) a value preliminarily set by the user using any standard input-output means of the computing device 100; or similar.

Furthermore, the computing module 40 is additionally configured to form language pairs to be learned by the user. These pairs are formed from the most frequently encountered (most frequent) words in a known language, as determined by the computing module 40, and their translations into the target language. The translations can be obtained by the computing module 40 by directing a request to the above-described vocabulary database, which is stored in the local data storage 50 (or, depending on the embodiment—as described above—in a separate local data storage via the connection bus 60 and/or in the data source 200 via the connection module 10, connected to the connection bus 60). The computing module 40 can obtain access to this database by means of the connection bus 60.

In other words, each language pair to be learned by the user, formed by the computing module 40, contains: a word in a known language, which is essentially one of the words in the known language most frequently encountered in the specific set of words in a known language and having a translation into the target language not yet known to the user; and, put into correspondence with it, the translation of that word into the target language. This translation is obtained by the computing module 40 as a result of directing a search request to the aforementioned vocabulary database associated with the indicated word in the known language.

It is to note that the computing module 40 ensures the possibility of recording or saving each of the language pairs to be learned by the user, formed by the computing module 40 as a result of processing a specific set of words in a known language, in the local data storage 50. Depending on the embodiment, as described above in the present document, this can be in a separate local data storage with the use of the connection bus 60 and/or in the data source 200 with the use of the connection module 10, which is connected to the connection bus 60. The computing module 40 can obtain access to this storage by means of the connection bus 60.

In some embodiments of the present invention, each such language pair to be learned by the user, formed by the computing module 40 in the above-described manner, can be saved in the above-described database corresponding to the vocabulary reserve of the user, or in the above-described personal dictionary for the target language. Such a database (corresponding to the user's vocabulary reserve) and such a personal dictionary can be stored together or separately in the local data storage 50 (or, as described, in a separate local data storage or the data source 200). The computing module 40 can obtain access to this storage by means of the connection bus 60. Alternatively, they can even constitute a single database.

It is to note that the computing module 40 ensures the possibility of outputting a word to the user—either a word in a known language or a word in the target language—from at least one of the language pairs to be learned by the user, as formed by the computing module 40. In particular, to output a word to the user from each such language pair, the computing module 40 directs a request into the local data storage 50 (or, depending on the embodiment, as described above, into a separate local data storage with the use of the connection bus 60 and/or into the data source 200 with the use of the connection module 10, which is connected to the connection bus 60). The computing module 40 can obtain access to this storage by means of the connection bus 60. This request ensures the possibility of extracting from there the word that is subject to output to the user, and the computing module 40 then ensures the possibility of outputting the extracted word to the user.

It is to note that for outputting a word to the user from a language pair to be learned, the following can be used, for example: the display module 20, which can display the indicated word to the user; or a speaker of the computing device 100, which can provide a sound representation of the indicated word, generated by the computing module 40.

Furthermore, thanks to its connection with the user interface module 30, the computing module 40 is configured to receive from it data on a translation indicated by the user. This translation pertains to a word that was output to the user and that forms part of the corresponding language pair to be learned by the user—a pair previously formed by the computing module 40 and saved in the local data storage 50. Additionally, the computing module 40 is configured to check the indicated word translation for correctness.

In some embodiments of the present invention, also thanks to its connection with the user interface module 30, the computing module 40 can be further configured to receive from it: data on a translation into the target language indicated by the user in relation to at least one word in a known language; or data on a translation into the known language indicated by the user in relation to at least one word in the target language. This occurs during the conduction of the above-described preliminary testing of the user's vocabulary reserve.

Furthermore, the computing module 40 is additionally configured to check the correctness of the translation indicated by the user, which is contained in the data obtained from the user interface module 30. This checking is performed with the possibility of recording a result (positive or negative) in the local data storage 50. Depending on the embodiment, as described above, this can be in a separate local data storage via the connection bus 60 and/or in the data source 200 via the connection module 10, which is connected to the connection bus 60. The computing module 40 can obtain access to this storage by means of the connection bus 60. The recorded result is associated with the checked word, which in turn is associated with the language pair to be learned by the user to which the checked word belongs.

In particular, to check the correctness of a translation indicated by the user via the user interface module 30 for a word output to the user (a word corresponding to one of the language pairs to be learned by the user), the computing module 40 can use a vocabulary database. This database is preliminarily saved in the local data storage 50 (or, depending on the embodiment—as described above—in a separate local data storage via the connection bus 60 and/or in the data source 200 via the connection module 10, connected to the connection bus 60). The computing module 40 has or can obtain access to this database by means of the connection bus 60.

Thus, each translation indicated by the user for a word output to the user (a word corresponding to one of the language pairs to be learned) is compared by the computing module 40 against the vocabulary database. This comparison allows the determination of the correctness of the user's indicated translation of the word into the known language (if the word was output in the target language) or of the correct translation of the word into the target language (if the word was output in a known language).

Thus, upon checking the correctness of the translation for a word output to the user (a word corresponding to one of the language pairs to be learned by the user), the computing module 40 ensures the possibility of outputting a message to the user about the result of the correctness check. Such a message can indicate a positive or negative result of the check in relation to the user's indicated translation for the output word. Furthermore, in the case of a negative result (i.e., an incorrect translation), the message output to the user can additionally contain the correct (true) translation of the word.

In some embodiments of the present invention, simultaneously with outputting the message about the check result, the computing module 40 can also ensure the possibility of outputting to the user: the exact (true/correct) translation of the word; and additional information related to that translation (for example, correct stress, transcription, features of forming various parts of speech, other translation variants in different thematic areas, and the like).

It is to note that, thanks to the connection of the computing module 40 with the display module 20, the message output to the user—which indicates the result of checking the correctness of the user's indicated translation for the output word—can take the form of a static image, a dynamic image, or a text message displayed on the display module 20.

In some embodiments, the message output to the user, which indicates the result of checking the correctness of the user's indicated translation for the output word, can be a sound message generated by a speaker (not shown) built into the computing device 100.

In some embodiments, the message output to the user, which indicates the result of checking the correctness of the user's indicated translation for the output word, can be a vibration signal generated by a vibrator (not shown) built into the computing device 100.

In other embodiments, the message output to the user, which indicates the result of checking the correctness of the user's indicated translation for the output word, can be a tactile element built into the body of the computing device 100 or the display module 20. This tactile element has a tactilely distinguishable parameter selected from a group comprising: the height or extent of the tactile element; its thickness; the form of its cross-section; its stiffness; its temperature; its roughness; the frequency of its vibration; the degree of its displacement; and the angle of its rotation.

It is to note that after outputting the message to the user about the result of checking the correctness of the translation indicated by the user for a word output to the user (a word corresponding to one of the language pairs to be learned by the user, formed by the computing module 40 as a result of processing a specific set of words in a known language), the computing module 40 can ensure the possibility of outputting the following word (in a known language or in the target language). This next word corresponds to another language pair to be learned by the user, formed by the computing module 40 from the same set of words in a known language. The user is then to indicate the translation of this following word, and the computing module 40 carries out a subsequent check of the correctness of this translation.

It should also be noted that a cycle of teaching the target language to the user, corresponding to a specific set of words in a known language, can be completed in one of the following ways: (i) by the user voluntarily, using standard input-output means of the computing device or using the capability of the display module 20 to register touch input (piezoelectric effect) if the display module 20 is implemented as a touch display module; (ii) upon outputting to the user words in a known language or in the target language for the user to indicate their translation, where the quantity of words output corresponds to all language pairs to be learned formed by the computing module 40 from that specific set of words, or to a set portion (in quantitative terms) of those formed language pairs; (iii) upon reaching a set threshold value, such as a set quantity of positive results or negative results (errors) from checking the correctness of the user's indicated translation for each word output to the user for translation indication, where each word corresponds to a language pair to be learned formed by the computing module 40 from the specific set of words; and/or similar.

In one embodiment of the present invention, each or at least one word corresponding to a language pair to be learned—formed by the computing module 40 from a specific set of words in a known language—for which the user incorrectly indicated the translation, can be output again to the user. The user then indicates its translation again, either within the same teaching cycle corresponding to that specific set of words, or within at least one or each subsequent teaching cycle corresponding to other sets of words in a known language.

In one variation of this embodiment, at least one or each such word (from a language pair formed from the specific set, with an incorrectly indicated translation) can be output again by the computing module 40 to the user within the same teaching cycle. The user must again indicate its translation (into the target language if the word was output in the known language, or into the known language if the word was output in the target language). This re-output can occur: (a) a set number of times; or (b) until the user correctly indicates the translation for the output word at least once (e.g., once, twice, three times) or a set number of times (i.e., until the number of correctly indicated translations for that specific word reaches a set threshold).

In another variation of this embodiment, at least one or each language pair to be learned—formed by the computing module 40 from a specific set of words in a known language, and for which the word's translation was incorrectly indicated during the current teaching cycle—can be saved in the local data storage 50 (or, as described above, in a separate local data storage via the connection bus 60 and/or in the data source 200 via the connection module 10, connected to the connection bus 60). The computing module 40 has or can obtain access to this storage via the connection bus 60. Subsequently, this language pair can be added to other language pairs to be learned that will be formed by the computing module 40 from at least one or each other set of words in a known language used in subsequent teaching cycles.

In particular, the transfer of a language pair to be learned to at least one subsequent teaching cycle (i.e., adding it to the set of language pairs used in one or more subsequent cycles) can be performed by the computing module 40 if, for example, the user incorrectly indicated the translation for the word output from that language pair during the current teaching cycle at least once or a set number of times.

In some embodiments of the present invention, the user can continue the execution of a suspended or interrupted cycle of teaching the target language to the user using the computing device 100. Upon the suspension or interruption of such a cycle, the computing module 40 ensures the possibility of saving in the local data storage 50 (depending on the embodiment, as described above in the present document, in a separate local data storage with the use of the connection bus 60 and/or in the data source 200 with the use of the connection module 10, which is connected to the connection bus 60) the data on the language pairs to be learned by the user. Specifically, it saves data for those pairs for which, within the framework of the indicated cycle, words had not yet been output to the user for the user to indicate their translation. The computing module 40 has access or can obtain access to this storage by means of the connection bus 60.

In such embodiments of the present invention, the return to the execution of the suspended or interrupted cycle of teaching the target language to the user can be performed: by the user using the standard means of input-output built into the computing device 100; by the user using the capability of the display module 20 to register touch input (piezoelectric effects) in the case where the display module 20 is implemented as a touch display module; or automatically upon expiration of a set period of time registered by the computing module 40, or upon the onset of another event registered by the computing module 40.

It is to note that in such embodiments, upon returning to the execution of the suspended or interrupted cycle, the computing module 40 extracts from the local data storage 50 (or, depending on the embodiment—as described above—from a separate local data storage with the use of the connection bus 60 and/or from the data source 200 with the use of the connection module 10, connected to the connection bus 60) the data on the language pairs to be learned by the user for which, within the suspended or interrupted cycle, words had not yet been output to the user for translation indication. The computing module 40 then ensures the possibility of providing to the user one or more words, each corresponding to one of those previously unused language pairs, for the user to indicate its translation.

In other embodiments of the present invention, the user can repeat the execution of at least one or each of the previously passed or completed cycles of teaching the target language to the user (including the just completed cycle) with the use of the computing device 100.

It is to note that upon the completion of each such cycle, the computing module 40 can ensure the possibility of saving in the local data storage 50 (depending on the embodiment, as described above in the present document, in a separate local data storage with the use of the connection bus 60 and/or in the data source 200 with the use of the connection module 10, which is connected to the connection bus 60) the data on the language pairs learned by the user during that cycle. Specifically, it saves data on those language pairs each of which corresponds to a word that was output to the user within the completed cycle for the user to indicate its translation, and for which the user ultimately correctly indicated the requested translation. The computing module 40 has access or can obtain access to this storage by means of the connection bus 60.

In such embodiments, the repeated execution of a previously passed or completed cycle can be performed: by the user using the standard means of input-output built into the computing device 100; by the user using the capability of the display module 20 to register touch input (piezoelectric effects) if the display module 20 is implemented as a touch display module; or automatically upon expiration of a set period of time registered by the computing module 40, or upon the onset of another event registered by the computing module 40.

It is to note that in such embodiments, upon the repeated execution of a previously passed or completed cycle, the computing module 40 extracts from the local data storage 50 (or, depending on the embodiment—as described above—from a separate local data storage with the use of the connection bus 60 and/or from the data source 200 with the use of the connection module 10, connected to the connection bus 60) the data on the language pairs learned by the user. That is, it extracts data on pairs each corresponding to a word that was provided to the user within the originally completed cycle for translation indication, and for which the user ultimately correctly indicated the translation. The computing module 40 then ensures the possibility of providing to the user one or more words, each corresponding to one of those previously learned language pairs, for the user to indicate its translation.

With reference to FIG. 2, there is shown the system 2000 for teaching a user a target language to be learned by the user. This system comprises the computing device 150 for teaching a user a target language to be learned by the user according to the second aspect of the present invention. The system 2000 shown in FIG. 2 is essentially an alternative to the system 1000 for teaching a user a target language to be learned by the user described above and shown in FIG. 1.

It is to note that the computing device 150 according to the second aspect has, for the most part, a structure, internal connections, and main functional modules similar to those of the computing device 100 according to the first aspect, as described above. Consequently, most of the detailed information about system 2000 and computing device 150 is omitted herein. In particular, it should be considered that the description provided above in relation to computing device 100 and its specific embodiments essentially also relates to computing device 150, shown in FIG. 2. Furthermore, it should be considered that the description provided above in relation to the connection module 10, the computing module 40, the local data storage 50, and the connection bus 60—as they pertain to computing device 100—essentially also relates to the corresponding functional components constituting computing device 150. The computing device 150, shown in FIG. 2, differs from computing device 100 (shown in FIG. 1) only in that it contains a touch display module 70 instead of the functionally connected display module 20 and user interface module 30 described for computing device 100. However, it is to note that the functional capabilities of the touch display module 70, which is part of computing device 150, are essentially a combination or unification of the functional capabilities inherent to display module 20 and user interface module 30. Therefore, a description of the touch display module 70's functional capabilities is also omitted herein. In particular, the functional capabilities of touch display module 70 correspond to those of display module 20 as described above for embodiments of computing device 100 according to the first aspect, in which the display module 20 is implemented as a touch display module or touch display capable of registering touch input (piezoelectric effects) resulting from the user pressing or touching it.

### Method of Teaching a User a Target Language to Be Learned by the User

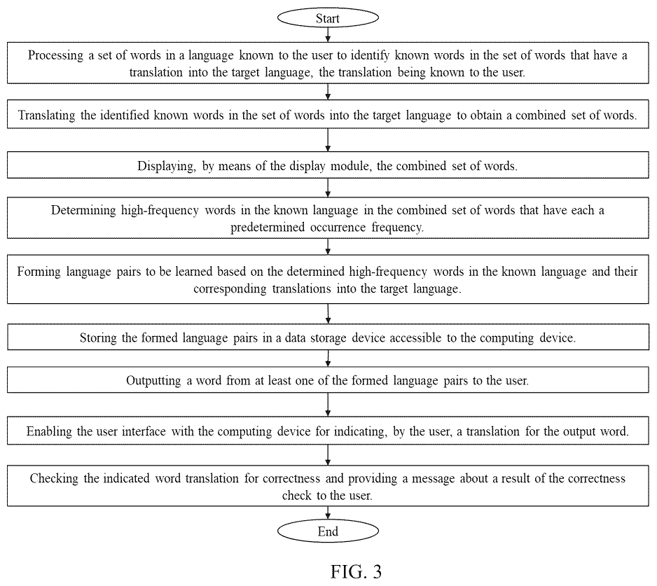

FIG. 3 is a block diagram illustrating main operations of a method of teaching a user a target language to be learned by the user according to the third aspect of the present invention.

The method of teaching a user a target language to be learned by the user as shown in FIG. 3 can be implemented by using the computing device 100 according to the first aspect (shown in FIG. 1 as a part of the system 1000) or the computing device 150 according to the second aspect (shown in FIG. 2 as a part of the system 2000). Furthermore, the method shown in FIG. 3 can be also implemented by using any computing or computer device known in the art that is equipped with a display module or a display, including the above-described general-purpose computer equipped with or connected to a display device.

Thus, it is obvious for one skilled in the art that the computing device used to perform at least some operations of the method may be the computing device 100, the computing device 150 or any other suitable computing device known in the art.

Furthermore, it is obvious for one skilled in the art that the storage device used to save the results of at least some operations of the method and/or to extract data necessary for performing at least some operations may be the local data storage 50, the data source 200 and/or any other suitable storage device known in the art.

It is also obvious for one skilled that the display module used to display the results of at least some operations may be the display module 20, any other suitable display known in the art, or any other suitable displaying device known in the art.

It is also obvious for one skilled that the user interface with the computing device, used for performing at least some operations, can be implemented by using: standard input-output means of the computing device; the capability of the display module of the computing device to register a touch input (i.e. a piezoelectric effect) when the display module is implemented as a touch display; or any other suitable method described herein or known in the art.

The method of teaching a user a target language to be learned by the user, as shown in FIG. 3, includes at least the following main operations or stages:
(i) processing a set of words in a language known to the user to identify known words in the set of words that have a translation into the target language, the translation being known to the user;
(ii) translating the identified known words in the set of words into the target language to obtain a combined set of words;
(iii) displaying, by means of the display module, the combined set of words;
(iv) determining high-frequency words in the known language in the combined set of words that have each a predetermined occurrence frequency;
(v) forming language pairs to be learned based on the determined high-frequency words in the known language and their corresponding translations into the target language;
(vi) storing the formed language pairs in a data storage device accessible to the computing device;
(vii) outputting a word from at least one of the formed language pairs to the user;
(viii) enabling the user interface with the computing device for indicating, by the user, a translation for the output word; and
(ix) checking the indicated word translation for correctness and providing a message about a result of the correctness check to the user.

At an additional stage of the method shown in FIG. 3, at least one language pair corresponding to a word output to the user for translation indication can be recorded in the aforementioned personal dictionary of the user (stored on a storage device accessible to the computing device) upon a positive result of the correctness check.

In one embodiment of the present invention, the aforementioned functions of computing module 40 can be performed by a processor that is part of computing device 100 or computing device 150.

According to another embodiment, computing module 40 can be divided into several independent modules. Each such module can perform at least one of the functions inherent to computing module 40 and can be configured to connect to each other and to the remaining functional modules of computing device 100 or 150 via the connection bus 60.

In one embodiment of the present invention, the method according to the third aspect further includes, before performing the stage (i) of processing the set of words in the known language, determining, by means of the computing device, known words in the target language that have each a translation into the known language, the translation being known to the user.

In one variation of this embodiment, before performing stage (i), the following operations are performed:
(a) outputting, by means of the computing device, words in the target language to the user;
(b) enabling the user interface with the computing device for indicating, by the user, a proposed translation into the known language for each of the output words in the target language;
(c) checking, by means of the computing device, the indicated proposed translation for correctness; and
(d) forming a set of known words in the target language based on words in the target language that correspond to proposed translations correctly indicated by the user.

In yet another variation, before performing stage (i), the following operations are performed:
(a) outputting, by means of the computing device, words in the known language;
(b) enabling the user interface with the computing device for indicating, by the user, a proposed translation into the target language for each of the output words in the known language;
(c) checking, by means of the computing device, the indicated proposed translation for correctness; and
(d) forming a set of known words in the target language based on words in the target language that correspond to proposed translations correctly indicated by the user.

In another variation, before performing stage (i), the user forms, by means of the computing device, a set of known words in the target language that are associated with their translations into the known language.

In another embodiment of the present invention, in the method of teaching a user a target language to be learned by the user according to the third aspect of the present invention, before the execution of the stage (i) of said method, wherein a set of words in a language known to the user is processed to identify known words that have a translation into the target language, the translation being known to the user, at least one word spoken by the user is recorded (for example, with the use of a microphone built into the computing device, or by any other suitable method known in the art), and the indicated recorded word is recognized by means of the computing device to identify the known language.

In yet another embodiment, in the method according to the third aspect, before performing stage (ii) (translating the identified known words), two or more translation variants into the target language for at least one of the identified known words are displayed on the display module. Furthermore, the user interface with the computing device is enabled for the user to select one of the displayed translation variants.

In another embodiment, the method according to the third aspect can include an additional operation or stage. In this stage, the user interface with the computing device is enabled for the user to input one or more additional language pairs to be learned, each formed from a word in the known language and a translation of that word into the target language.

In some other embodiment of the present invention, the method according to the third aspect can include the following additional stages or operations:
(a) forming a text in the known language based on the determined high-frequency words in accordance with a predetermined text formation model;
(b) identifying known words in the formed text that have a translation into the target language, the translation being known to the user; and
(c) translating the identified known words in the formed text into the target language and displaying, by means of the display module, the translations of the identified known words.

In some other embodiment of the present invention, the method according to the third aspect can include the following additional stages or operations:
(a) forming a text in the target language based on the determined high-frequency words in accordance with a predetermined text formation model;
(b) identifying known words in the formed text that have each a translation into the known language, the translation being known to the user; and
(c) translating the identified known words in the formed text into the known language and displaying, by means of the display module, translations of the identified known words.

In some embodiments of the present invention, the method according to the third aspect can include the following additional stages or operations:
(a) enabling the user interface with the computing device for inputting, by the user, a message in the target language;
(b) identifying known words in the inputted message that have each a translation into the known language, the translation being known to the user;
(c) translating the inputted message into the known language;
(d) displaying, by means of the display module, the translation of the inputted message; and
(e) providing the translated message to an addressee.

In one variation of such embodiments, for each of the untranslated words in the inputted message, the following operations are additionally performed:
displaying, by means of the display module, one or more suggested translation variants of the untranslated word into the known language; and
enabling the user interface with the computing device for selecting, by the user, a particular translation variant into the known language from the displayed suggested translation variants.

In one variation of such embodiments, for each of the untranslated words in the inputted message, the following operations are additionally performed:
enabling the user interface with the computing device for indicating, by the user, a translation variant of the untranslated word into the known language;
forming a language pair to be learned by the user based on the untranslated word in the target language and the indicated translation variant into the known language; and
storing the formed language pair in a data storage device accessible to the computing device.

In other embodiments, in the method according to the third aspect, upon receiving, by means of the computing device, a message in the known language, the following operations are additionally performed:
identifying known words in the received message that have each a translation into the target language, the translation being known to the user; and
translating the inputted message into the target language and displaying, by means of the display module, the translation of the inputted message.

The illustrative embodiments, examples, and description provided herein are presented solely to ensure understanding of the essence of the claimed invention and are not limiting. Other possible embodiments will be apparent to a person skilled in the art from the foregoing description. The scope of the present invention is defined solely by the accompanying claims.

1. A computing device for translating words into a target language, the computing device comprising:
a computing module for receiving a set of words in a known language and performing at least the following operations:
identifying known words in the received set of words that have a known translation into the target language by comparing each word in the received set of words with a user vocabulary database stored in a storage device accessible to the computing module, and
translating the identified known words in the received set of words into the target language so as to obtain a combined set of words; and
a display module operatively coupled to the computing module for displaying the obtained combined set of words,
wherein the computing module is further configured to perform at least the following operations:
determining high-frequency unknown words having unknown translation into the target language in the obtained combined set of words that have each a pre-determined occurrence frequency,
forming language pairs to be learned by the user based on the determined high-frequency unknown words and their corresponding translations into the target language, and
allowing a word from at least one of the formed language pairs to be outputted to the user,
wherein the computing device further comprises a user interface module for enabling the user to indicate a translation for the output word, and
wherein the computing module is further operatively coupled to the user interface module to receive data on the indicated word translation, and
wherein the computing module is further configured to check the indicated word translation for correctness and to add the language pair corresponding to the checked word to the user vocabulary database if the indicated word translation is correct.

2. A computing device for translating words into a target language, the computing device comprising:
a computing module for receiving a set of words in a known language er and performing at least the following operations:
identifying known words in the received set of words that have a known translation into the target language by comparing each word in the received set of words with a user vocabulary database stored in a storage device accessible to the computing module, and
translating the identified known words in the received set of words into the target language to obtain a combined set of words; and
a touch display module operatively coupled to the computing module for displaying the obtained combined set of words,
wherein the computing module is further configured to perform at least the following operations:
determining high-frequency unknown words having unknown translation into the target language in the obtained combined set of words that have each a predetermined occurrence frequency,
forming language pairs to be learned by the user based on the determined high-frequency unknown words and their corresponding translations into the target language, and
allowing a word from at least one of the formed language pairs to be outputted to the user,
wherein the touch display module is further configured to enable the user to indicate a translation for the output word, and
wherein the computing module is further configured to receive data on the indicated word translation from the touch display module, and
wherein the computing module is further configured to check the indicated word translation for correctness and to add the language pair corresponding to the checked word to the user vocabulary database if the indicated word translation is correct.

3. A method of translating words into a target language, the method being performed on a computing device comprising a display module and including:
processing a set of words in a known language to identify known words in the set of words that have a known translation into the target language by comparing each word in the set of words with a user vocabulary database stored in a storage device accessible to the computing module;
translating the identified known words in the set of words into the target language to obtain a combined set of words;
displaying the combined set of words on the display module;
determining high-frequency unknown words having unknown translation into the target language in the obtained combined set of words that have each a predetermined occurrence frequency;
forming language pairs to be learned based on the determined high-frequency unknown words and their corresponding translations into the target language,
storing the formed language pairs in the storage device;
outputting a word from at least one of the formed language pairs to the user;
enabling the user interface with the computing device for indicating, by the user, a translation for the output word; and
checking the indicated word translation for correctness and
adding the language pair corresponding to the checked word to the user vocabulary database if the indicated word translation is correct.

4. The method of claim 3, further including, prior to processing the set of words in the known language:
determining with the computing device known words in the target language that have each a known translation into the known language.

5. The method of claim 4, wherein the step of determining the words in the target language comprises performing at least the following operations prior to processing the set of words in the known language:
outputting with the computing device words in the target language to the user;
enabling the user interface with the computing device for indicating, by the user, a proposed translation into the known language for each of the output words in the target language;
checking with the computing device the indicated proposed translation for correctness; and
forming a set of known words in the target language based on words in the target language that correspond to proposed translations correctly indicated by the user.

6. The method of claim 4, wherein the step of determining the words in the target language comprises performing at least the following operations prior to processing the set of words in the known language:
outputting with the computing device words in the known language;
enabling the user interface with the computing device for indicating, by the user, a proposed translation into the target language for each of the output words in the known language;
checking with the computing device the indicated proposed translation for correctness; and
forming a set of known words in the target language based on words in the target language that correspond to proposed translations correctly indicated by the user.

7. The method of claim 4, wherein the step of determining the words in the target language comprises, prior to processing the set of words in the known language:
enabling the user to form with the computing device a set of known words in the target language that are associated with their translations into the known language.

8. The method of claim 3, further comprising, prior to processing the set of words in the known language:
enabling the user interface with the computing device for defining, by the user, the known language.

9. The method of claim 3, further comprising, prior to processing the set of words in the known language:
recording at least one word spoken by the user; and
recognizing said recorded word to identify the known language.

10. The method of claim 3, further comprising, prior to translating the identified known words into the target language:
displaying two or more translation variants into the target language for at least one of the identified known words on the display module; and
enabling the user interface with the computing device for selecting, by the user, one of the displayed translation variants.

11. The method of claim 3, further comprising
enabling the user interface with the computing device for inputting, by the user, one or more additional language pairs to be learned, each being formed from a word in the known language and a translation of said word into the target language.

12. The method of claim 3, further comprising
forming a text in the known language based on the determined high-frequency words in accordance with a predetermined text formation model;
identifying known words in the formed text that have a known translation into the target language; and
translating the identified known words in the formed text into the target language and displaying the translations of the identified known words on the display module.

13. The method of claim 3, further comprising
forming a text in the target language based on the determined high-frequency words in accordance with a predetermined text formation model;
identifying known words in the formed text that have each a known translation into the known language; and
translating the identified known words in the formed text into the known language and
displaying translations of the identified known words on the display module.

14. The method of claim 3, further comprising
enabling the user interface with the computing device for inputting, by the user, a message in the target language;
identifying known words in the inputted message that have each a known translation into the known language;
translating the inputted message into the known language
displaying the translation of the inputted message on the display module and
providing the translated message to an addressee.

15. The method of claim 14, further comprising, for each untranslated word in the inputted message,
displaying one or more suggested translation variants of the untranslated word into the known language on the display module; and
enabling the user interface with the computing device for selecting, by the user, a particular translation variant into the known language from the displayed suggested translation variants.

16. The method according to claim 14, further comprising, for each untranslated word in the inputted message,
enabling the user interface with the computing device for indicating, by the user, a translation variant of the untranslated word into the known language;
forming a language pair to be learned by the user based on the untranslated word in the target language and the indicated translation variant into the known language; and
storing the formed language pair in a data storage device accessible to the computing device.

17. The method according to claim 15, further comprising, for each untranslated word in the inputted message,
enabling the user interface with the computing device for indicating, by the user, a translation variant of the untranslated word into the known language;
forming a language pair to be learned by the user based on the untranslated word in the target language and the indicated translation variant into the known language; and
storing the formed language pair in a data storage device accessible to the computing device.
